(19) United States
(12) Patent Application Publication
(10) Pub. No.: US 2018/0229623 A1
(43) Pub. Date: Aug. 16, 2018

(54) CONTROL SYSTEMS FOR HYDRAULICALLY ACTUATED TRANSMISSIONS OF ELECTRIC VEHICLES

(71) Applicant: BorgWarner Inc., Muenchen (DE)

(72) Inventor: Richard BAEUMLER, Muenchen (DE)

(21) Appl. No.: 15/516,485

(22) PCT Filed: Sep. 29, 2015
(86) PCT No.: PCT/US15/52798

§ 371 Date: Apr. 3, 2017

Related U.S. Application Data
(60) Provisional application No. 62/061,997, filed on Oct. 9, 2014.

(51) Int. Cl. B60L 15/20; F16H 61/00; F16H 61/02

(52) U.S. Cl. CPC B60L 15/2054; F16H 61/0025; F16H 2061/0037; F16H 2061/0034; F16H 61/0206

(57) ABSTRACT

A system (18) for a transmission (16) of an electric vehicle, including: a pump (34), accumulator (36), control valve (38), sensor (40), check valve (42), and sequence valve (44). The accumulator (36) stores fluid from the pump (34). The control valve (38) modulates pressure to the transmission (16) from the pump (34). The sensor (40) is between the control valve (38) and transmission (16) and generates a signal. The check valve (42) is between the accumulator (36) and pump (34). The sequence valve (44) has: an input (56) communicating with the pump (34), an output (58) communicating with the accumulator (36), a closed position (44A) wherein flow is interrupted between the accumulator (36) and pump (34), and an open position (44B) wherein fluid from the pump (34) can be stored in the accumulator (36); and is movable between positions (44A, 44B) in response to changes in the sensor (40) signal.

### BACKGROUND OF INVENTION

### 1. Field of Invention

The present invention relates, generally, to electric vehicle transmissions and, more specifically, to control systems for hydraulically actuated multispeed transmissions of electric vehicles.

### 2. Description of the Related Art

Conventional electric vehicle powertrains known in the art typically include a battery powered electric motor that outputs rotational torque. When compared to conventional internal combustion engines, modern electric motors tend to operate efficiently within a broader range of rotational speeds. In particular, electric motors operate and generate rotational torque at relatively high rotational speeds without excessive noise generation and wear, as is common with high-revving internal combustion engines. Thus, depending on the configuration of the vehicle, the electric motor may be used to translate rotational torque directly to one or more wheels of the vehicle so as to drive the vehicle in operation. In certain applications, a transmission is used to adjust the rotational speed and torque generated by the electric motor such that the vehicle can, for example, travel at greater speeds, be configured with a higher curb weight, and/or carry a greater payload. The transmission typically includes a gearset, such as a planetary gearset, that multiplies rotational speed and torque by a predetermined drive ratio.

To further optimize the efficiency of the electric motor, the transmission may be configured as a “multispeed” transmission that can be shifted between one or more gearsets to operate in different “speeds” or “gears” that each correspond to a different drive ratio. Because of the high rotational speeds and efficiency at which electric motors operate, transmissions for electric vehicles may include a relatively smaller number of gearsets (for example, 2-3) when compared to transmissions used with conventional internal combustion engines, where the trend in the art is to include a larger number of gearsets (for example, 6-10). However, it will be appreciated that transmissions with a small number of gearsets may necessitate a large difference in drive ratios of adjacent gearsets, depending on the application. With a large difference in drive ratios, it becomes difficult for the transmission to smoothly change between gearsets due to the correspondingly large change in rotational speed that occurs at the electric motor during gearset engagement. Thus, to ensure smooth modulation between gearsets, the transmission may include one or more clutch assemblies modulated by a control system so as to effect engagement and disengagement with the electric motor. To that end, the control system may include a controller, a pump assembly, sensors, and/or solenoid valves. The clutch assemblies are typically lubricated by and actuated with hydraulic fluid that is pressurized by the pump assembly and regulated by one or more solenoid valves. The controller cooperates with the sensors to monitor various operating parameters of the transmission, and is used to actuate the solenoid valves to modulate the clutch assemblies.

Each of the components of the control system of the type described above must cooperate to effectively modulate translation of rotational torque between the electric motor, transmission, and wheels. In addition, each of the components must be designed not only to facilitate improved performance and efficiency, but also so as to reduce the cost and complexity of manufacturing electric vehicles. While control systems known in the related art have generally performed well for their intended use, there remains a need in the art for a control system that has superior operational characteristics, a reduced overall packaging size, reduced parasitic losses, increased efficiency and, at the same time, that reduces the cost and complexity of manufacturing electric vehicles.

### SUMMARY OF THE INVENTION

The present invention overcomes the disadvantages in the related art in a hydraulic control system for use with a multispeed transmission of an electric vehicle. The hydraulic control system includes a pump assembly, an accumulator, at least one control valve, at least one sensor, a check valve, and a sequence valve. The pump assembly is used to pressurize hydraulic fluid and has a pump output. The accumulator is used to store pressurized hydraulic fluid. The control valve is in fluid communication with the pump output and is used to modulate hydraulic pressure to the transmission. The sensor is disposed between the control valve and the transmission and generates a signal representing at least one of hydraulic fluid pressure, temperature, viscosity, and/or flow rate. The check valve includes an inlet in fluid communication with the accumulator, and an outlet in fluid communication with the pump output. The sequence valve includes a valve input in fluid communication with the pump output, and a valve output in fluid communication with the accumulator. The sequence valve has a closed position wherein pressurized fluid from the pump assembly is prevented from flowing toward the accumulator, and an open position wherein pressurized fluid from the pump assembly can be stored in the accumulator. The sequence valve is movable between the closed position and the open position in response to predetermined changes in the signal generated by the sensor.

In addition, the present invention is directed toward a system for use in controlling translation of rotational torque generated by an electric motor through a planetary gearset of an automotive transmission modulated by at least two hydraulically-actuated clutch assemblies. The system includes an electric control module, a pump assembly, an accumulator, a plurality of control valves, at least two sensors, a check valve, and a sequence valve. The pump assembly is in electrical communication with the electronic control module, is used to pressurize hydraulic fluid, and has a pump output. The accumulator is used to store pressurized hydraulic fluid. The control valves are for each of the respective clutch assemblies and are used to modulate hydraulic pressure thereto. Each of the control valves are in fluid communication with the pump output and in electrical communication with the electronic control module. The sensors are in electrical communication with the electronic control module, are disposed between each of the control valves and the respective clutch assemblies, and are used to generate a signal representing at least one of hydraulic fluid pressure, temperature, viscosity, and/or flow rate. The check valve includes an inlet in fluid communication with the accumulator, and an outlet in fluid communication with the pump output. The sequence valve is in electrical communication with the electronic control module and includes a valve input in fluid communication with the pump output and a valve output in fluid communication with the accumulator. The sequence valve has a closed position wherein pressurized fluid from the pump assembly is prevented from flowing toward the accumulator, and an open position wherein pressurized fluid from the pump assembly can be stored in the accumulator. The sequence valve is movable between the closed position and the open position by the electronic control module in response to predetermined changes in the signal generated by the sensor.

Further, the present invention is directed toward a method of operating an automotive transmission having a planetary gearset modulated by at least two hydraulically-actuated clutch assemblies so as to control translation of rotational torque generated by an electric motor. The method includes the steps of: providing an electronic control module; a pump assembly in electrical communication with the electronic control module for pressurizing hydraulic fluid and having a pump output; and an accumulator for storing pressurized hydraulic fluid. The method also includes the step of providing a control valve for each of the respective clutch assemblies for modulating hydraulic pressure thereto, each of the control valves being in fluid communication with the pump output and in electrical communication with the electronic control module; and at least two sensors in electrical communication with the electronic control module, disposed between each of the control valves and the respective clutch assemblies, for generating a signal representing at least one of hydraulic fluid pressure, temperature, viscosity, and/or flow rate. The method further includes the step of providing a check valve including an inlet in fluid communication with the accumulator and an outlet in fluid communication with the pump output; and a sequence valve in electrical communication with the electronic control module. The sequence valve includes a valve input in fluid communication with the pump output and a valve output in fluid communication with the accumulator, and has a closed position wherein pressurized fluid from the pump assembly is prevented from flowing toward the accumulator, and an open position wherein pressurized fluid from the pump assembly can be stored in the accumulator. The method also includes the steps of moving the sequence valve to the closed position with the electronic control module; driving the pump assembly with the electronic control module so as to translate pressurized hydraulic fluid to each of the control valves; actuating each of the control valves with the electronic control module so as to modulate the clutches of the transmission; and moving the sequence valve to the opened position with the electronic control module in response to predetermined signals generated by at least one of the sensors and received by the electronic control module.

In this way, the control systems and method of the present invention significantly improve modulation of the clutch assemblies of the transmission by ensuring supply of pressurized hydraulic fluid thereto during all operating conditions of the electric vehicle. Moreover, the present invention reduces the cost and complexity of manufacturing electric vehicles that have superior operational characteristics, such as high efficiency and improved component packaging, component life, and drivability.

### BRIEF DESCRIPTION OF THE DRAWINGS

Other objects, features, and advantages of the present invention will be readily appreciated as the same becomes better understood after reading the subsequent description taken in connection with the accompanying drawing wherein:

FIG. 1 is a schematic plan view of a powertrain of an electric vehicle having a hydraulically-actuated multispeed transmission, according to one embodiment of the present invention.

FIG. 2 is a hydraulic schematic view of a control system for use with the multispeed transmission of FIG. 1, in a first configuration.

FIG. 3 is a hydraulic schematic view of a control system for use with the multispeed transmission of FIG. 1, in a second configuration.

### DETAILED DESCRIPTION OF THE INVENTION

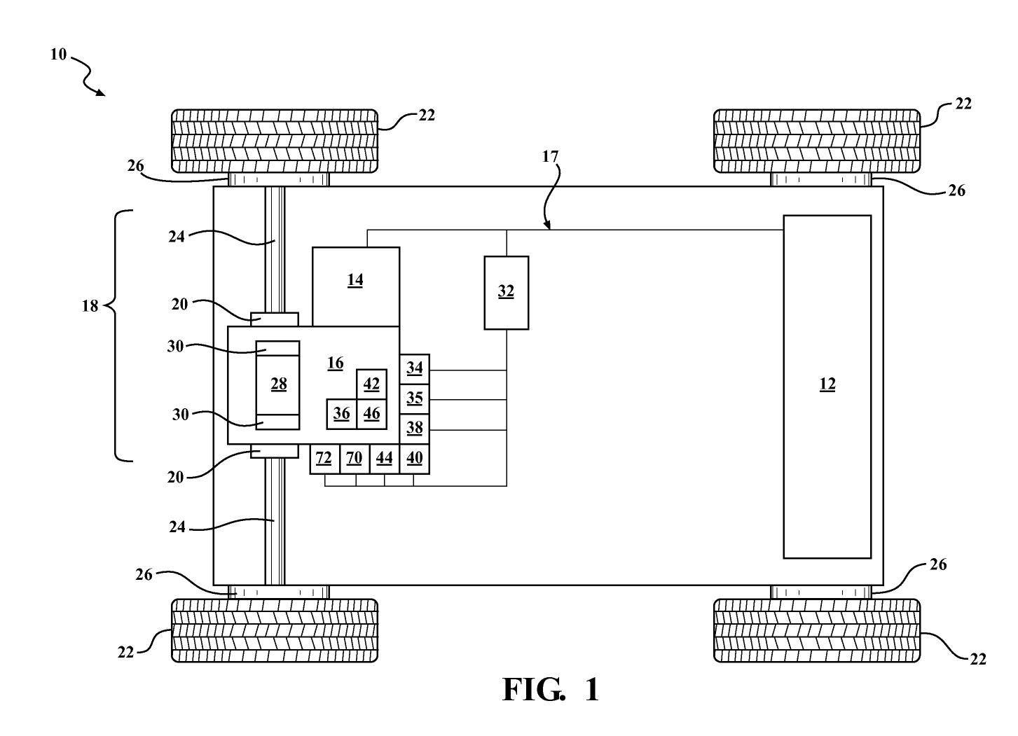

Referring now to the figures, where like numerals are used to designate like structure, a portion of an electric vehicle drivetrain is schematically illustrated at 10 in FIG. 1. The drivetrain 10 includes a battery 12, an electric motor 14, a multispeed transmission 16, and a control system 18. The electric motor 14 is powered by the battery 12, generates rotational torque, and is in rotational communication with the transmission 16. The transmission 16 adjusts the rotational speed and torque from the electric motor 14 and is configured to output adjusted rotational torque, as discussed in greater detail below.

The electric motor 14 and battery 12 are in electrical communication via a wiring harness 17 configured such that current can be translated between the battery 12 and electric motor 14. Depending on the operating mode of the drivetrain 10, current could flow either toward the battery 12 (such as with regenerative braking via the electric motor 14), or from the battery 12 (such as with the electric motor 14 being used to drive the vehicle). The battery 12 is typically spaced from the electric motor 14 so as to balance weight distribution of the drivetrain 10, but could be disposed in any suitable location without departing from the scope of the present invention. While the battery 12 is shown as a single integrated unit, it will be appreciated that the battery 12 could be configured in any suitable way without departing from the scope of the present invention. By way of non-limiting example, a plurality of batteries 12, spaced from each other or grouped together, could be used.

As shown in FIG. 1, the electric motor 14 and transmission 16 are operatively attached to one another and are oriented in what is referred to in the art a “transverse” configuration. However, it will be appreciated that the electric motor 14 and transmission 16 could be oriented in any suitable way without departing from the scope of the present invention. Moreover, the transmission 16 could be spaced from the electric motor 14, so as to improve weight distribution of the drivetrain 10, without departing from the scope of the present invention.

The transmission 16 includes at least one output 20 that is in rotational communication with one or more wheel and tire assemblies 22 (hereinafter referred to as a “wheel”). To that end, a continuously variable joint 24 may be operatively attached to the output 20 and wheel 22 such that rotational torque is translated from the transmission 16 to the wheel 22 so as to drive the vehicle in operation. In the representative embodiment illustrated herein, the drivetrain 10 is “front wheel drive,” whereby the transmission 16 has a pair of outputs 20 to which respective continuously variable joints 24 are operatively attached. The continuously variable joints 24 each translate rotational torque to mounting hubs 26 used to support wheels 22 at the front of the vehicle drivetrain 10. However, those having ordinary skill in the art will appreciate that there are a number of different ways the drivetrain 10 could be configured and, thus, that any suitable number of wheels 22 could be driven, in any suitable way, using any suitable number of electric motors 14, batteries 12, or transmissions 16, without departing from the scope of the present invention. By way of non-limiting example, the drivetrain 10 could be configured such that the transmission 16 has a single output 20 connected to a driveshaft (not shown, but generally known in the art) which, in turn, is connected to a differential (not shown, but generally known in the art) that subsequently drives a pair of wheels 20. Moreover, depending on the application of the electric vehicle drivetrain 10, it will be appreciated that the transmission 16 may include or otherwise cooperate with a differential.

The transmission 16 is configured as a multispeed automatic and can be operated in different “speeds” or “gears” that each correspond to a different drive ratio between the electric motor 14 and the output 20. To that end, the transmission 16 may include one or more gearsets 28, such as a planetary gearset, to adjust the rotational speed and torque generated by the electric motor 14, as discussed above. The transmission 16 may also include one or more hydraulically-actuated clutch assemblies 30 for selectively modulating engagement between the electric motor 12, outputs 20, and gearsets 28. In the representative embodiment illustrated herein, the transmission 16 includes a pair of clutch assemblies 30A, 30B that are modulated by the control system 18, which includes an electronic control module 32, a pump assembly 34, an accumulator 36, and one or more control valves 38, sensors 40, check valves 42, and sequence valves 44. Each of these components will be described in greater detail below.

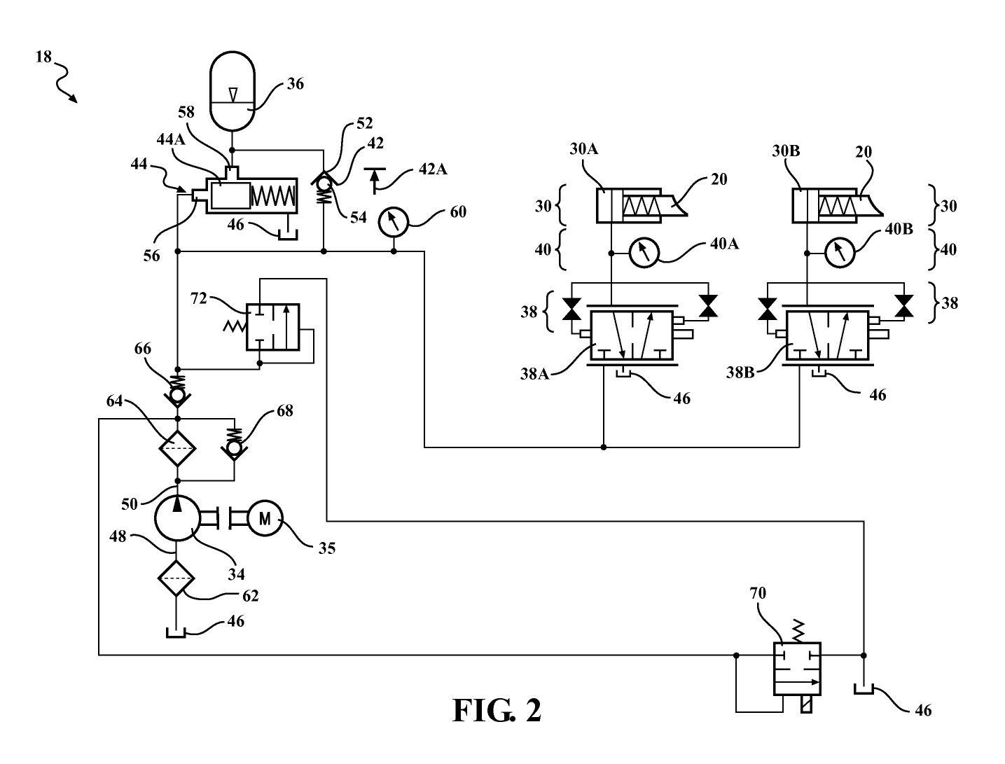

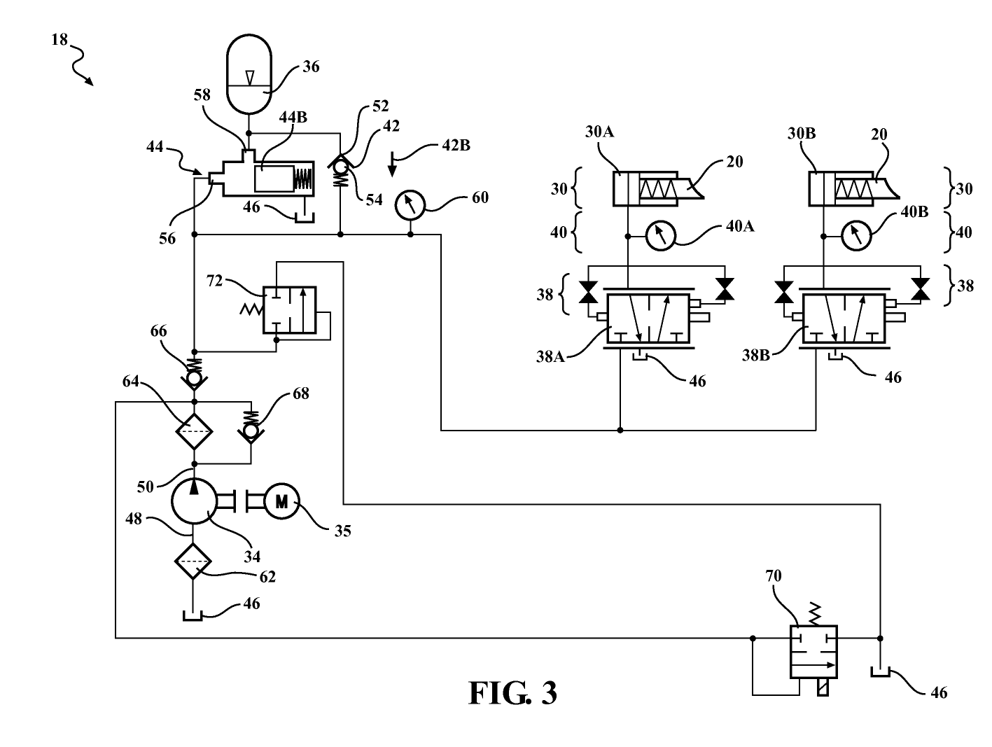

Referring now to FIGS. 2 and 3, the transmission 16 is both lubricated by and actuated with hydraulic fluid. To that end, the transmission 16 has a reservoir 46 for storing non-pressurized hydraulic fluid. The reservoir 46 may also be in fluid communication with the valves 38, 44 for accommodating residual fluid during actuation of the valves 38, 44. The pump assembly 34 has a pump input 48 in fluid communication with the reservoir 46, and a pump output 50 in selective fluid communication with the clutch assemblies 30A, 30B. In one embodiment, the pump assembly 34 is powered by a conventional electric pump motor 35 that is in electrical communication with the electronic control module 32 and/or battery 12. However, those having ordinary skill in the art will appreciate that the pump assembly 34 could be of any suitable type, powered in any suitable way, with or without the use of an electric pump motor 35, without departing from the scope of the present invention. The pump assembly 34 is used to pressurize hydraulic fluid from the reservoir 46 and translates the hydraulic fluid to the transmission 16 via the pump output 50, as described in greater detail below.

As noted above, the control system 18 includes an accumulator 36 used to store pressurized hydraulic fluid. More specifically, the accumulator 36 cooperates with the check valve 42 and sequence valve 44 to selectively store hydraulic fluid pressurized by the pump assembly 34, as described in greater detail below. The accumulator 36 is a conventional gas-charged hydraulic accumulator, but those having ordinary skill in the art will appreciate that the accumulator 36 could be of any suitable type without departing from the scope of the present invention.

The check valve 42 has an inlet 52 in fluid communication with the accumulator 36, and an outlet 54 in fluid communication with the pump output 50 of the pump assembly 34. In one embodiment, the check valve 42 has a check position, indicated by flow path T-arrow 42A (see FIG. 2) and an uncheck position, indicated by flow path arrow 42B (see FIG. 3). In the check position 42A, pressurized hydraulic fluid is prevented from flowing: from the accumulator 36 the control valve 38; and from the pump assembly 34 to the accumulator 36. In the uncheck position 42B, pressurized fluid flows from the accumulator 36 to the control valve 38. The check valve 42 is movable between the check 42A and uncheck 42B positions in response to a predetermined pressure differential occurring across the check valve 42. In one embodiment, the pressure differential is less than 1 bar in magnitude. Thus, the check valve 42 effectively prevents over-charging of the accumulator 36 and, at the same time, allows the accumulator 36 to translate hydraulic fluid to the control valve 38 so as to equalize the fluid pressure of the accumulator 36 to the fluid pressure of the pump output 50 of the pump assembly 34.

The control valve 38 is in fluid communication with the pump output 50 of the pump assembly 34 and is used to modulate hydraulic pressure to the transmission 16. More specifically, and as illustrated in FIGS. 2 and 3, the control system 18 may include two control valves 38A, 38B, each allocated to one of the respective clutch assemblies 30A, 30B of the transmission 16 for modulating hydraulic pressure thereto. The control valves 38A, 38B are each in fluid communication with the pump output 50 of the pump assembly 34, and are in electrical communication with the electronic control module 32. The control valves 38A, 38B are configured as solenoid valves that are actuated by the electronic control module 32 so as to modulate the clutch assemblies 30A, 30B. It will be appreciated that there are many different types of solenoid valves known in the art and, thus, the control valves 38A, 38B could be of any suitable type, actuated in any suitable way, without departing from the scope of the present invention. By way of non-limiting example, the control valves 38A, 38B may be cycled, such as by pulse width modulation (PWM), or may include variable position control, actuated such as with a stepper motor.

As noted above, the control system 18 of the present invention also includes a sensor 40. The sensor 40 is disposed between the control valve 38 and the respective clutch assembly 30 and is used to generate a signal representing at least one of hydraulic fluid pressure, temperature, viscosity, and/or flow rate. It will be appreciated that the control system 18 may include more than one sensor 40, and that individual sensors 40A, 40B could be allocated to each of the clutch assemblies 30A, 30B of the transmission 16, depending on the application. The sensors 40A, 40B are in electrical communication with the electronic control module 32, which may be configured to monitor the sensors 40A, 40B and adjust modulation of the respective clutch assemblies 30A, 30B via the control valves 38A, 38B in response to predetermined changes in signals generated by the sensors 40A, 40B. In one embodiment, at least one of the sensors 40A, 40B is a pressure transducer for generating a signal representing the hydraulic fluid pressure between the respective control valve 38 and the corresponding clutch assembly 30 of the transmission 16.

As noted above, the control system 18 of the present invention also includes a sequence valve 44 that cooperates with the check valve 42 and accumulator 36. The sequence valve 44 has a valve input 56 in fluid communication with the pump output 50 of the pump assembly 34, and a valve output 58 in fluid communication with the accumulator 36. The sequence valve 44 is a solenoid valve that is in electrical communication with and is actuated by the electronic control module 32. It will be appreciated that there are many different types of solenoid valves known in the art and, thus, the sequence valve 44 could be of any suitable type, actuated in any suitable way, without departing from the scope of the present invention. By way of non-limiting example, sequence valve 44 may be cycled, such as by pulse width modulation (PWM), or may include variable position control, actuated such as with a stepper motor.

The sequence valve 44 has a closed position 44A (see FIG. 2) and an open position 44B (see FIG. 3). In the closed position 44A, pressurized fluid from the pump assembly 34 is prevented from flowing toward the accumulator 36. In the open position 44B, pressurized fluid from the pump assembly 34 can be stored in the accumulator 36.

The sequence valve 44 is movable between the closed position 44A and the opened position 44B in response to predetermined changes in the signal generated by the sensor 40. More specifically, the electronic control module 32 moves the sequence valve 44 between the positions in response to changes in the hydraulic pressure between the control valve 38 and clutch assembly 30 of the transmission 16. Those having ordinary skill in the art will appreciate that hydraulic fluid in the transmission 16 heats up during operation, and predetermined changes in the temperature of hydraulic fluid result in a corresponding change in the viscosity of the hydraulic fluid. As such, where a specific hydraulic pressure is needed to actuate the control valve 38 so as to modulate the clutch assembly 30 to properly operate the transmission 16, the volume of hydraulic fluid required to achieve the requisite hydraulic pressure varies with operating temperature. Thus, the sequence valve 44 enables a predetermined volume of hydraulic fluid to be stored in the accumulator 36 under certain transmission 16 operating conditions, such as at initial “cold start” use.

In one embodiment, the control system 18 may include additional sensors, such as a line sensor 60 disposed between the pump output 50 of the pump assembly 34 and the valve input 56 of the sequence valve 44 for generating a line signal representing at least one of hydraulic fluid pressure, temperature, viscosity, and/or flow rate. The electronic control module 32 may be in electrical communication with the line sensor 60, and may use the signal generated by the line sensor 60 to selectively control modulation of the sequence valve 44. However, those having ordinary skill in the art will appreciate that the control system 18 could be configured differently, with or without the use of a line sensor 60, without departing from the scope of the present invention.

In one embodiment, a suction filter 62 is disposed between the pump input 48 of the pump assembly 34 and the reservoir 46. The suction filter 62 protects the pump assembly 34 from particulates and other contamination that may accumulate in the hydraulic fluid. A pressure filter 64, operatively attached to the pump output 50 before the valves 38, 44, provides additional filtering protection to the sequence valve 44 and control valves 38A, 38B from contamination, such as particulates deposited in the hydraulic fluid by the pump assembly 34. Further, a system check valve 66 may be operatively attached to the pressure filter 64 for preventing flow of pressurized hydraulic from the accumulator 36 toward the pump assembly 34. Likewise, a filter check valve 68 may be disposed in parallel with the pressure filter 64 so as to effectively bypass the pressure filter 64 under certain operating conditions, such as where the pressure filter 64 becomes clogged and would otherwise restrict flow of hydraulic fluid to the valves 44, 38.

In one embodiment, a lubrication valve 70 in electrical communication with the electronic control module 32 is disposed between the pump output 50 of the pump assembly 34 and the reservoir 46, and is used to selectively direct hydraulic fluid to the transmission 16 for lubrication. While the lubrication valve 70 directs hydraulic fluid from the pump assembly 34 to the reservoir 46, those having ordinary skill in the art will appreciate that the lubrication valve 70 could direct hydraulic fluid to any suitable location in (or component of) the transmission 16, without departing from the scope of the present invention. In one embodiment, a pressure release valve 72 is disposed between the system check valve 66 and the reservoir 46, and is used to selectively bleed off pressure so as to regulate pressure to the valves 38, 44.

As noted above, the present invention is also directed toward a method of operating the multispeed transmission 16. The method includes the steps of: providing the electronic control module 32, the pump assembly 34, the accumulator 36, control valves 38A, 38B for each of the respective clutch assemblies 30A, 30B, at least two sensors 40, the check valve 42, and the sequence valve 44; moving the sequence valve 44 to the closed position 44A with the electronic control module 32; driving the pump assembly 34 with the electronic control module 32 so as to translate pressurized hydraulic fluid to each of the control valves 38; actuating each of the control valves 38A, 38B with the electronic control module 32 so as to modulate the clutch assemblies 30A, 30B of the transmission 16; and moving the sequence valve 44 to the opened position 44B with the electronic control module 32 in response to predetermined signals generated by at least one of the sensors 40A, 40B and received by the electronic control module 32.

In one embodiment, the step of moving the sequence valve 44 to the opened position 44B is preceded by the steps of: operating the electric motor 14 so as to generate rotational torque; and determining achievement of a predetermined operating condition of the transmission 16 with the electronic control module 32. By way of non-limiting example, the predetermined operating condition of the transmission 16 could be reaching a specific operating temperature or pressure.

In this way, the control system 18 of the present invention significantly improves the responsiveness and operation of the clutch assemblies 30A, 30B of the transmission 16 of the electric vehicle drivetrain 10. More specifically, it will be appreciated that the control system 18 enables the clutch assemblies 30A, 30B to be modulated by the control valves 38A, 38B with sufficient pressure generated directly by the pump assembly 34 during cold startup, whereby the sequence valve 44 controls or otherwise limits the fluid volume to be translated by the pump assembly 34 while the transmission 16 warms up and, at the same time, can be used to selectively store hydraulic fluid under pressure and provide the same to the control valves 38A, 38B as needed. Moreover, the control system 18 of the present invention reduces the cost and complexity of manufacturing electric vehicles that have superior operational characteristics, such as high efficiency and improved component packaging, component life, and vehicle drivability.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A hydraulic control system (18) for use with a multispeed transmission (16) of an electric vehicle, said hydraulic control system (18) comprising;
a pump assembly (34) for pressurizing hydraulic fluid, said pump assembly (34) having a pump output (50);
an accumulator (36) for storing pressurized hydraulic fluid;
at least one control valve (38) in fluid communication with said pump output (50) for modulating hydraulic pressure to the transmission (16);
at least one sensor (40) disposed between said at least one control valve (38) and the transmission (16), said sensor (40) generating a signal representing at least one of hydraulic fluid pressure, temperature, viscosity, and/or flow rate;
a check valve (42) including an inlet (52) in fluid communication with said accumulator (36), and an outlet (54) in fluid communication with said pump output (50); and
a sequence valve (44) including a valve input (56) in fluid communication with said pump output (50), and a valve output (58) in fluid communication with said accumulator (36), said sequence valve (44) having:
a closed position (44A) wherein pressurized fluid from said pump assembly (34) is prevented from flowing toward said accumulator (36), and
an open position (44B) wherein pressurized fluid from said pump assembly (34) can be stored in said accumulator (36),
said sequence valve (44) being movable between said closed position (44A) and said open position (44B) in response to predetermined changes in said signal generated by said sensor (40).

2. The hydraulic control system (18) as set forth in claim 1, further including a line sensor (60) disposed between said pump output (50) and said valve input (56) of said sequence valve (44) for generating a line signal representing at least one of hydraulic fluid pressure, temperature, viscosity, and/or flow rate.

3. The hydraulic control system (18) as set forth in claim 1, wherein said check valve (42) has:
a check position (42A), wherein pressurized fluid is prevented from flowing from said accumulator (36) to said control valve (38); and from said pump assembly (34) to said accumulator (36), and
an uncheck position (42B), wherein pressurized fluid flows from said accumulator (36) to said control valve (38),
said check valve (42) being movable between said check position (42A) and said uncheck position (42B) in response to a predetermined pressure differential occurring across said check valve (42).

4. The hydraulic control system (18) as set forth in claim 1, further including a reservoir (46) for storing non-pressurized fluid, said reservoir (46) being in fluid communication with a pump input (48) of said pump assembly (34).

5. The system as set forth in claim 4, further including a lubrication valve (70) disposed between said pump output (50) and said reservoir (46) for directing hydraulic fluid to the transmission (16) for lubrication.

6. The system as set forth in claim 4, further including a suction filter (62) disposed between said pump input (48) and said reservoir (46).

7. The system as set forth in claim 1, further including a pressure filter (64) operatively attached to said pump output (50).

8. A system for use in controlling translation of rotational torque generated by an electric motor (14) through a planetary gearset (28) of a multispeed transmission (16) modulated by at least two hydraulically-actuated clutch assemblies (30A, 30B), said system comprising:
an electronic control module (32);
a pump assembly (34) in electrical communication with said electronic control module (32) for pressurizing hydraulic fluid, said pump assembly (34) having a pump output (50);
an accumulator (36) for storing pressurized hydraulic fluid;
a control valve (38A, 38B) for each of the respective clutch assemblies (30A, 30B) for modulating hydraulic pressure thereto, each of said control valves (38A, 38B) being in fluid communication with said pump output (50) and in electrical communication with said electronic control module (32);
at least two sensors (40A, 40B) in electrical communication with said electronic control module (32), disposed between each of said control valves (38A, 38B) and the respective clutch assemblies (30A, 30B), for generating a signal representing at least one of hydraulic fluid pressure, temperature, viscosity, and/or flow rate;
a check valve (42) including an inlet (52) in fluid communication with said accumulator (36), and an outlet (54) in fluid communication with said pump output (50); and
a sequence valve (44) in electrical communication with said electronic control module (32), said sequence valve (44) including a valve input (56) in fluid communication with said pump output (50) and a valve output (58) in fluid communication with said accumulator (36), said sequence valve (44) having:
a closed position (44A) wherein pressurized fluid from said pump assembly (34) is prevented from flowing toward said accumulator (36), and
an open position (44B) wherein pressurized fluid from said pump assembly (34) can be stored in said accumulator (36);
said sequence valve (44) being movable between said closed position (44A) and said open position (44B) by said electronic control module (32) in response to predetermined changes in said signal generated by said sensors (40A, 40B).

9. The system as set forth in claim 8, further including a line sensor (60) disposed between said pump output (50) and said valve input (56) of said sequence valve (44) for generating a line signal representing at least one of hydraulic fluid pressure, temperature, viscosity, and/or flow rate.

10. The system as set forth in claim 8, wherein said check valve (42) has:
a check position (42A), wherein pressurized fluid is prevented from flowing: from said accumulator (36) to each of said control valves (38A, 38B); and from said pump assembly (34) to said accumulator (36), and
an uncheck position (42B), wherein pressurized fluid flows from said accumulator (36) to each of said control valves (38A, 38B),
said check valve (42) being movable between said check position (42A) and said uncheck position (42B) in response to a predetermined pressure differential occurring across said check valve (42).

11. The system as set forth in claim 8, further including a reservoir (46) for storing non-pressurized fluid, said reservoir (46) being in fluid communication with a pump input (48) of said pump assembly (34).

12. The system as set forth in claim 11, further including a lubrication valve (70) in electrical communication with said electronic control module (32), disposed between said pump output (50) and said reservoir (46), for directing hydraulic fluid to the transmission (16) for lubrication.

13. The system as set forth in claim 11, further including a suction filter (62) disposed between said pump input (48) and said reservoir (46).

14. The system as set forth in claim 8, further including a pressure filter (64) operatively attached to said pump output (50).

15. A method of operating a multispeed transmission (16) having a planetary gearset (28) modulated by at least two hydraulically-actuated clutch assemblies (30A, 30B) so as to control translation of rotational torque generated by an electric motor (14), said method comprising the steps of:
providing: an electronic control module (32); a pump assembly (34) in electrical communication with said electronic control module (32) for pressurizing hydraulic fluid, said pump assembly (34) having a pump output (50); an accumulator (36) for storing pressurized hydraulic fluid; a control valve (38A, 38B) for each of the respective clutch assemblies (30A, 30B) for modulating hydraulic pressure thereto, each of said control valves (38A, 38B) being in fluid communication with said pump output (50) and in electrical communication with said electronic control module (32); at least two sensors (40A, 40B) in electrical communication with said electronic control module (32), disposed between each of said control valves (38A, 38B) and the respective clutch assemblies (30A, 30B), for generating a signal representing at least one of hydraulic fluid pressure, temperature, viscosity, and/or flow rate; a check valve (42) including an inlet (52) in fluid communication with said accumulator (36), and an outlet (54) in fluid communication with said pump output (50); and a sequence valve (44) in electrical communication with said electronic control module (32), said sequence valve (44) including a valve input (56) in fluid communication with said pump output (50) and a valve output (58) in fluid communication with said accumulator (36), said sequence valve (44) having a closed position (44A) wherein pressurized fluid from said pump assembly (34) is prevented from flowing toward said accumulator (36) and an open position (44B) wherein pressurized fluid from said pump assembly (34) can be stored in said accumulator (36);
moving said sequence valve (44) to said closed position (44A) with said electronic control module (32);
driving said pump assembly (34) with said electronic control module (32) so as to translate pressurized hydraulic fluid to each of said control valves (38A, 38B);
actuating each of said control valves (38A, 38B) with said electronic control module (32) so as to modulate the clutches (30A, 30B) of the transmission (16);
moving said sequence valve (44) to said opened position with said electronic control module (32) in response to predetermined signals generated by at least one of said sensors (40A, 40B) and received by said electronic control module (32).
